(19) United States
(12) Patent Application Publication
(10) Pub. No.: US 2025/0092932 A1
(43) Pub. Date: Mar. 20, 2025

(54) SHOCK ASSEMBLY WITH POSITION DEPENDENT RESERVOIR FLOW

(71) Applicant: Fox Factory, Inc., Duluth, GA (US)

(72) Inventors: Geoffrey Tyler Carlisle, El Cajon, CA (US); Bobby Lee Smith, JR., El Cajon, CA (US)

(21) Appl. No.: 18/470,761

(22) Filed: Sep. 20, 2023

(51) Int. Cl. F16F 9/346

(52) U.S. Cl. CPC F16F 9/346; F16F 2222/12; F16F 2230/183

(57) ABSTRACT

A shock assembly with internal bypass having position dependent reservoir flow is provided. The shock assembly includes a twin tube shock body having an inner tube and an outer tube. The shock assembly also includes a ring divider coupled between the inner body and the outer body to separate and form a fluid gap between the inner body and the outer body. The shock assembly includes bypass ports and bleeder ports formed in the inner body. Additionally, there are reservoir flow ports formed in the inner body and located above body divider ring, wherein the reservoir flow ports are configured to direct shaft displacement flow of fluid to a reservoir of the shock assembly when a piston of the shock assembly passes by the reservoir flow ports and into the bump zone during a compression stroke. This eliminates the risk of cavitation in the bump zone.

### BACKGROUND OF THE INVENTION

### Technical Field

This invention relates generally to a shock assembly with internal bypass and methods of use thereof.

### State of the Art

Conventional internal bypass shocks always have a risk of cavitation during compression strokes. Attempts to eliminate this risk of cavitation includes using base valves, however, the force that can generated before cavitation is limited wot the pressure the base valve can generate. Particularly in the bump zone of the shocks, this pressure from the base valve sometimes is not enough and the risk of cavitation can be much higher.

Accordingly, there is a need for an improved internal bypass shock assembly with position dependent reservoir flow that eliminates or reduces the risk of cavitation in the bump zone.

### SUMMARY OF THE INVENTION

An embodiment includes a shock assembly with internal bypass, the shock assembly comprising: a twin tube shock body comprising an inner tube and an outer tube; a ring divider coupled between the inner body and the outer body to separate and form a fluid gap between the inner body and the outer body, wherein the inner body and the outer body are sealed to allow fluid to flow through the gap without leaking; bypass ports and bleeder ports formed in the inner body; and reservoir flow ports formed in the inner body and located above body divider ring, wherein the reservoir flow ports are configured to direct shaft displacement flow of fluid to a reservoir of the shock assembly when a piston of the shock assembly passes by the reservoir flow ports during a compression stroke.

Another embodiment includes a method of use of a twin tube shock assembly with internal bypass, the method comprising: moving a piston of a shock assembly in a compression stroke, wherein the shock assembly comprises a ride zone with a primary internal bypass and a bump zone with a secondary internal bypass; directing displacement flow to a reservoir of the shock assembly through the primary internal bypass when the piston travels in the ride zone during the compression stroke; directing shaft displacement flow to a reservoir of the shock assembly through the secondary internal bypass when the piston travels in the bump zone during the compression stroke; and eliminating risk of cavitation during the compression stroke when the piston travels in the bump zone in response to directing shaft displacement flow through the secondary internal bypass.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a section view of a shock assembly with internal bypass and position dependent reservoir flow according to an embodiment;

FIG. 2 is a partial section view of a shock assembly with internal bypass and position dependent reservoir flow according to an embodiment;

FIG. 3 is a close-up partial section view of a shock assembly with internal bypass and position dependent reservoir flow according to an embodiment;

FIG. 4 is a partial section view of a shock assembly with internal bypass and position dependent reservoir flow depicting fluid flow when the piston is traveling through a ride zone according to an embodiment;

FIG. 5 is a partial section view of a shock assembly with internal bypass and position dependent reservoir flow depicting fluid flow when the piston is traveling through a bump zone according to an embodiment;

FIG. 6 is a partial section view of a shock assembly with internal bypass and position dependent reservoir flow depicting controlling fluid flow using poppets when the piston is traveling through a bump zone according to an embodiment;

FIG. 7 is a partial section view of a shock assembly with internal bypass and position dependent reservoir flow depicting primary bypass fluid according to an embodiment;

FIG. 8 is a partial section view of a shock assembly with internal bypass and position dependent reservoir flow depicting primary bypass fluid according to an embodiment; and

FIG. 9 is a flow chart depicting a method of using a shock assembly with internal bypass and position dependent reservoir flow according to an embodiment.

### DETAILED DESCRIPTION OF EMBODIMENTS OF THE INVENTION

As discussed above, embodiments of the present invention relate to an improved internal bypass shock assembly with position dependent reservoir flow that eliminates or reduces the risk of cavitation in the bump zone.

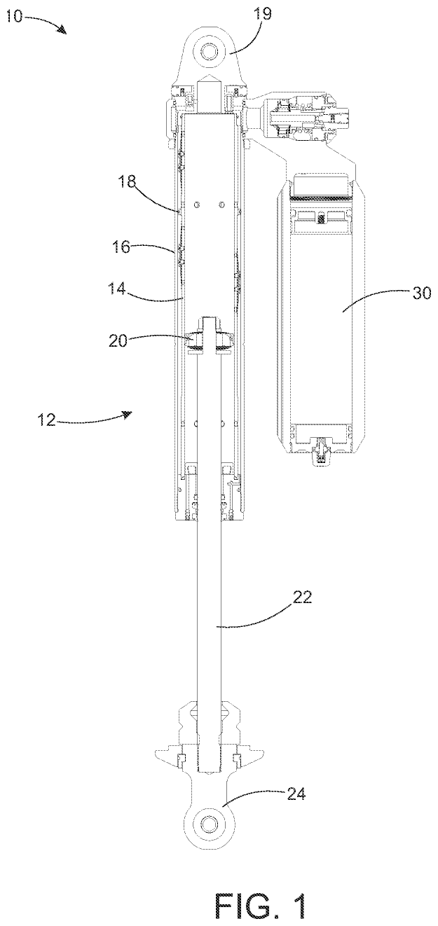

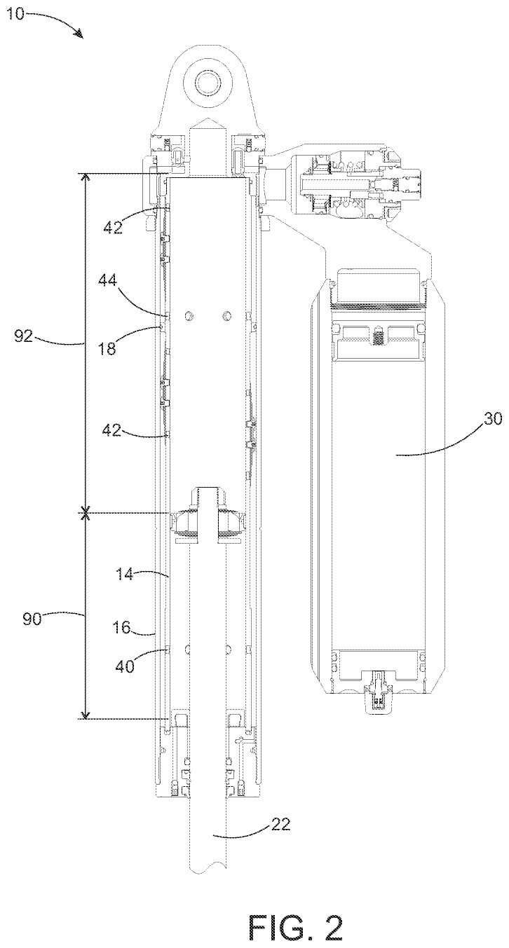

An embodiment of a shock assembly 10 is depicted in FIGS. 1-3. The shock assembly 10 comprises a twin tube shock body 12 having an inner body 14 and an outer body 16. The shock assembly 10 further comprises a ring divider 18 coupled between the inner body 14 and the outer body 16 to separate and form a fluid gap between the inner body 14 and the outer body 16. The inner body 14 and the outer body 16 are sealed to allow fluid to flow through the gap without leaking. An upper mount 19 is coupled to the twin tube shock body 12 and operates to couple the shock assembly 12 to a vehicle frame or body. The shock assembly 10 may further comprise a piston 20 with a piston shaft 22, the piston 20 configured to move within the inner body 14 during compression strokes and rebound strokes. The piston shaft 22 extends out of the twin tube shock body 12 and comprises a lower mount 24 coupled to an end of the piston shaft 22 and operates to couple the shock assembly 12 to suspension of the vehicle. The shock assembly 10 further comprises a reservoir 30 that is coupled to the twin tube shock body 12 and in fluid communication with the twin tube shock body 12 such that fluid in the shock body 12 can flow in both directions between the shock body 12 and the reservoir 30.

The shock body 12 may include an inner volume located within the inner body 14. The volume is divided by the piston 20 into a shaft side volume 90 and a top side volume 92. The shaft side volume 90 is the volume in the inner body 14 on the side of the piston 20 that the shaft 22 extends from and the top side volume 92 is on the side of the piston 20 opposite from where the shaft 22 extends. The shaft side volume 90 and the top side volume 92 change as the piston 20 moves within the inner body 14.

The twin tube shock assembly 10 may further comprise bypass ports 40 and bleeder ports 42 formed in the inner body 14. Further, the shock assembly 10 also comprises reservoir flow ports 44 formed in the inner body 14 and located above body divider ring 18, wherein the reservoir flow ports 44 are positioned between the body divider ring 18 and an end of the shock body 12 to which the upper mount 19 is coupled. It is this location of the reservoir flow ports 44 that allow the internal bypass shock 10 to create position dependent reservoir flow.

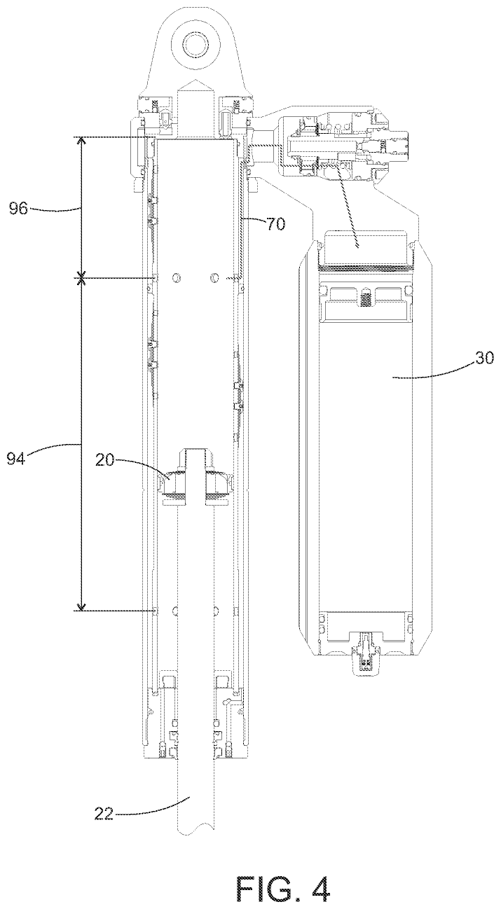

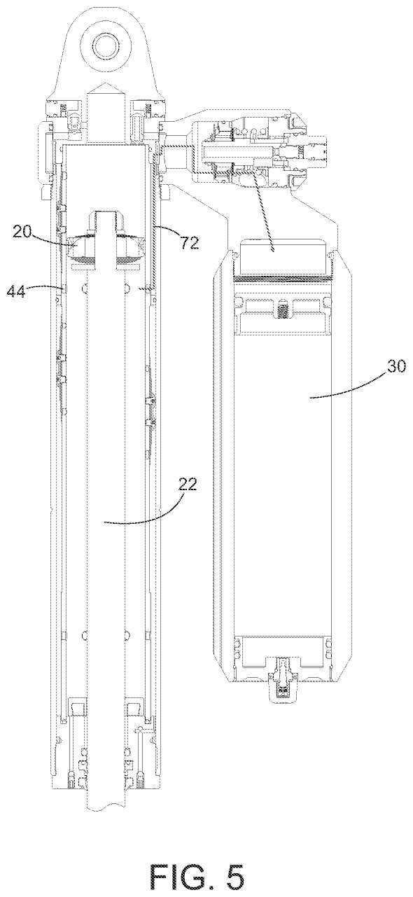

Referring additionally to FIGS. 4 and 5, the shock body 12 includes a ride zone 94 (also referred to as a primary internal bypass zone) defined between the bypass ports 40 and the reservoir flow ports 44. The shock body also includes a bump zone 96 (also referred to as a primary internal bypass zone) defined between the reservoir flow ports 44 and the end of the shock body 12 to which the upper mount 19 is coupled. In a compression stroke when the piston 20 is moving through the ride zone 94 toward the bump zone 96, the shaft displacement of fluid within the inner body 14 flows to the reservoir 30 from the topside volume 92 through the fluid gap between the inner body 14 and outer body 16 through the fluid gap between the inner body 14 and outer body 16 along a path 70, or in other words flows through the primary internal bypass as shown in FIG. 4. After the piston 20 passes the reservoir flow ports 44 and moves into the bump zone 96, the shaft displacement of fluid within the inner body 14 flows to the reservoir 30 from the shaft side volume 90 through the fluid gap between the inner body 14 and outer body 16 along a path 72, or in other words flows through the secondary internal bypass as shown in FIG. 5. Because of this flow from the shaft side volume 90 along through the secondary internal bypass when the piston 20 crosses over the reservoir flow ports 44 during a compression stroke, there is very little or even no risk of cavitation in the bump zone 96. This is accomplished because the location of the reservoir flow ports 44 ensures that there is always, at a minimum, nitrogen pressure on the rebound side of the piston 20.

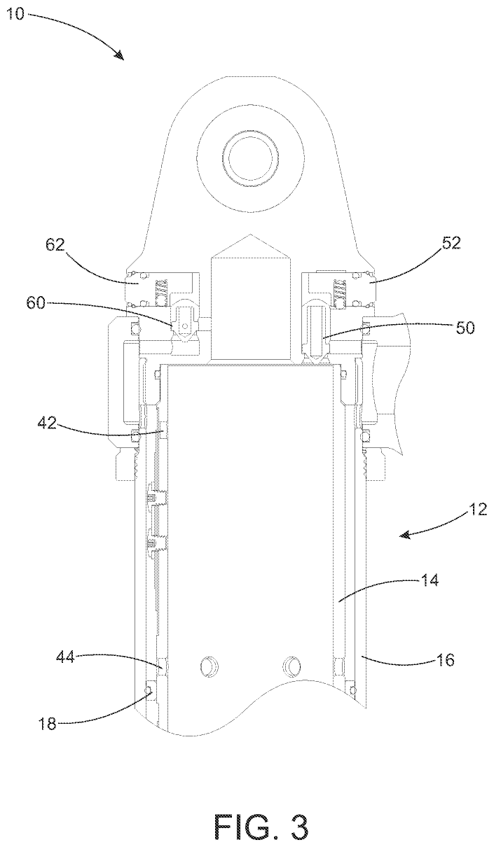

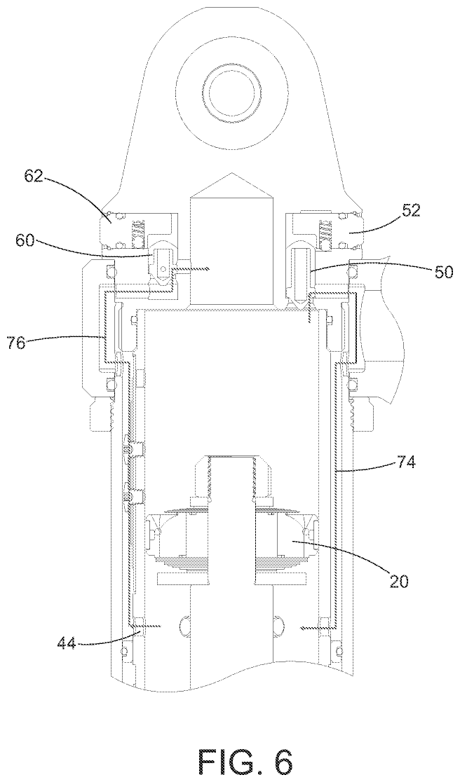

Referring to FIGS. 3 and 6, the shock assembly 10 may further comprise a first poppet 50 and a first adjuster 52 configured to control an amount of flow that can bypass the piston 20 only when the piston 20 is in the bump zone 96. The first poppet 50 operates as a check valve and closes during a rebound stroke so that the first poppet 50 and first adjuster 52 only affect compression forces by controlling flow through the fluid gap between the inner body 14 and outer body 16 along path 74. The shock assembly 10 may further comprise a second poppet 60 and a second adjuster 62 configured to control an amount of flow that can bypass the piston 20 only when the piston 20 is in the bump zone 96. The second poppet 60 operates as a check valve and closes during the compression stroke so that the second poppet 60 and second adjuster 62 only affect rebound forces by controlling flow through the fluid gap between the inner body 14 and outer body 16 along path 76. In embodiments, the poppets 50 and 60 may be pressure balanced when the piston 20 is in the ride zone 90 so that the adjusters 52 and 62 respectively only affect bump zone forces.

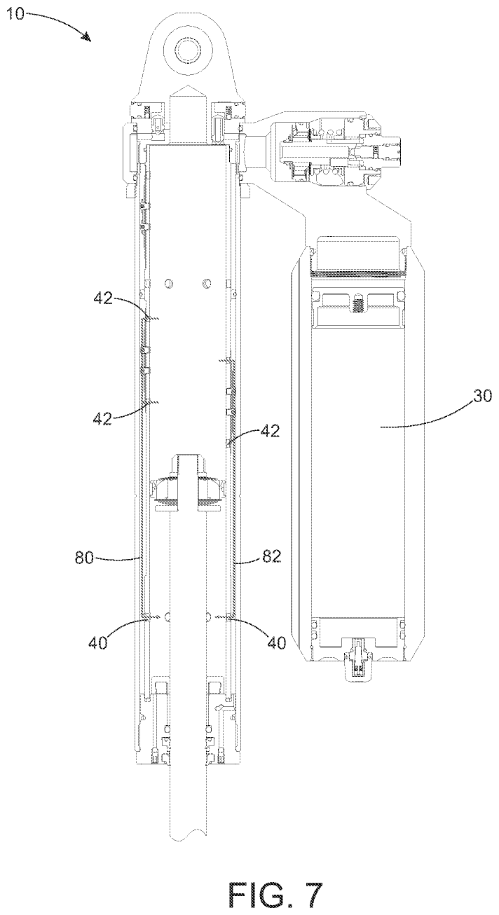

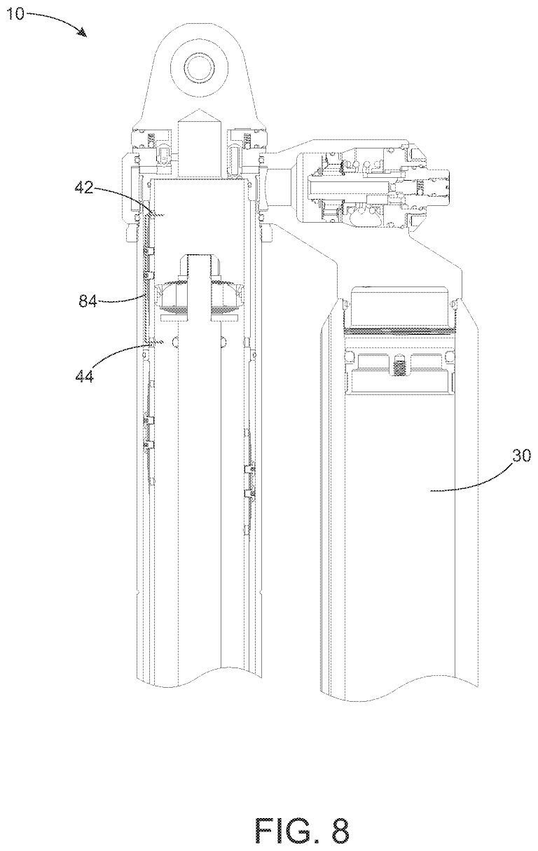

With additional reference to FIGS. 7 and 8, in embodiments depicted, the location in the travel where the piston 20 crosses the reservoir flow ports 44 can be used as a tuning feature that controls the length of the bump zone 96. In embodiments, as described previously, the bump zone 96 may also act as a secondary internal bypass zone where additional bypass/bleed ports 42 can be added that are only active when the piston 20 is in the bump zone 96. The primary internal bypass zone includes flow paths 80 and 82 through the fluid gap between the inner body 14 and outer body 16 as depicted in FIG. 7. The secondary internal bypass zone includes flow path 84 through the fluid gap between the inner body 14 and outer body 16 as depicted in FIG. 8. These additional bypass/bleed ports may be pressure balanced in the ride zone 90 so that they do not have an effect on the ride zone forces.

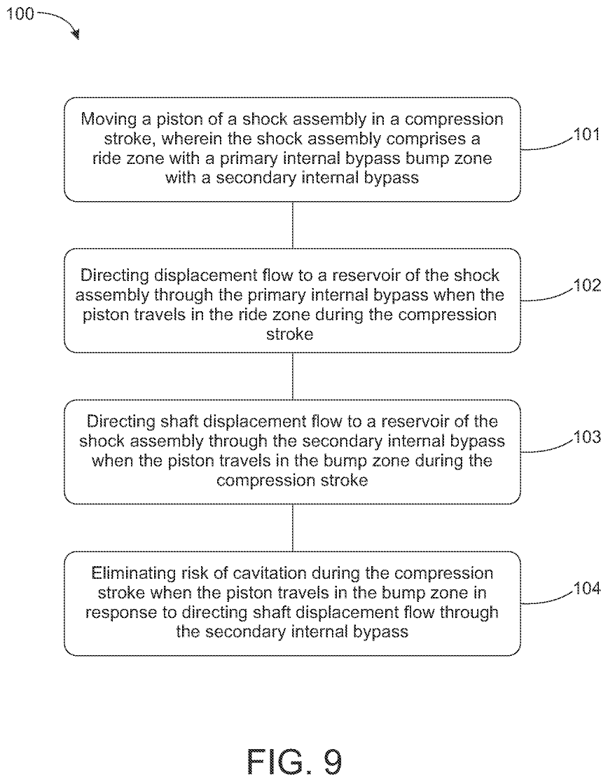

Referring to FIG. 9, an embodiment includes a method 100 of using a shock assembly with internal bypass is shown. The method 100 comprises moving a piston of a shock assembly in a compression stroke, wherein the shock assembly comprises a ride zone with a primary internal bypass and a bump zone with a secondary internal bypass (Step 101); directing displacement flow to a reservoir of the shock assembly through the primary internal bypass when the piston travels in the ride zone during the compression stroke (Step 102); directing shaft displacement flow to a reservoir of the shock assembly through the secondary internal bypass when the piston travels in the bump zone during the compression stroke (Step 103); and eliminating risk of cavitation during the compression stroke when the piston travels in the bump zone in response to directing shaft displacement flow through the secondary internal bypass (Step 104).

The method 100 may further comprise controlling an amount of flow that can bypass the piston through the secondary internal bypass with a first poppet and a first adjuster operating as a check valve that closes during a rebound stroke so that the first poppet and first adjuster only affect compression forces. Additionally, the method 100 may also comprise controlling an amount of flow that can bypass the piston through the secondary internal bypass with a second poppet and a second adjuster operating as a check valve that closes during the compression stroke so that the second poppet and second adjuster only affect rebound forces.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A shock assembly with internal bypass, the shock assembly comprising:
a twin tube shock body comprising an inner tube and an outer tube;
a ring divider coupled between the inner body and the outer body to separate and form a fluid gap between the inner body and the outer body, wherein the inner body and the outer body are sealed to allow fluid to flow through the gap without leaking;
bypass ports and bleeder ports formed in the inner body; and
reservoir flow ports formed in the inner body and located above body divider ring, wherein the reservoir flow ports are configured to direct shaft displacement flow of fluid to a reservoir of the shock assembly when a piston of the shock assembly passes by the reservoir flow ports during a compression stroke.

2. The shock assembly of claim 1, wherein the location of the reservoir flow ports marks a boundary between a primary internal bypass zone and a secondary internal bypass zone, wherein the secondary internal bypass zone is located on a side of the reservoir flow ports adjacent the reservoir and the primary internal bypass zone is located on an opposite side of the reservoir flow ports.

3. The shock assembly of claim 2, further comprising additional bypass/bleed ports located above the reservoir flow ports.

4. The shock assembly of claim 3, wherein the additional bypass/bleed ports are only active when the piston crossed the reservoir flow ports and is within the secondary internal bypass zone during the compression stroke.

5. The shock assembly of claim 1, further comprising a first poppet and a first adjuster configured to control an amount of flow that can bypass the piston only when the piston is in the bump zone.

6. The shock assembly of claim 5, wherein the first poppet operates as a check valve and closes during a rebound stroke so that the first poppet and first adjuster only affect compression forces.

7. The shock assembly of claim 1, further comprising a second poppet and a second adjuster configured to control an amount of flow that can bypass the piston only when the piston is in the bump zone.

8. The shock assembly of claim 7, wherein the second poppet operates as a check valve and closes during the compression stroke so that the second poppet and second adjuster only affect rebound forces.

9. A method of use of a twin tube shock assembly with internal bypass, the method comprising:
moving a piston of a shock assembly in a compression stroke, wherein the shock assembly comprises a ride zone with a primary internal bypass and a bump zone with a secondary internal bypass;
directing displacement flow to a reservoir of the shock assembly through the primary internal bypass when the piston travels in the ride zone during the compression stroke;
directing shaft displacement flow to a reservoir of the shock assembly through the secondary internal bypass when the piston travels in the bump zone during the compression stroke; and
eliminating risk of cavitation during the compression stroke when the piston travels in the bump zone in response to directing shaft displacement flow through the secondary internal bypass.

10. The method of claim 9, wherein the secondary internal bypass comprises a plurality of reservoir flow ports forming a boundary between the ride zone and bump zone.

11. The method of claim 10, wherein the piston moves from the ride zone into the bump zone by passing the plurality of reservoir flow ports during the compression stroke.

12. The method of claim 9, further comprising controlling an amount of flow that can bypass the piston through the secondary internal bypass with a first poppet and a first adjuster operating as a check valve that closes during a rebound stroke so that the first poppet and first adjuster only affect compression forces.

13. The method of claim 9, further comprising controlling an amount of flow that can bypass the piston through the secondary internal bypass with a second poppet and a second adjuster operating as a check valve that closes during the compression stroke so that the second poppet and second adjuster only affect rebound forces.

14. A shock assembly with internal bypass, the shock assembly comprising:
a twin tube shock body comprising an inner tube and an outer tube;
a ring divider coupled between the inner body and the outer body to separate and form a fluid gap between the inner body and the outer body, wherein the inner body and the outer body are sealed to allow fluid to flow through the gap without leaking;
bypass ports and bleeder ports formed in the inner body; and
at least one reservoir flow port formed in the inner body and located above body divider ring, wherein the at least one reservoir flow port is configured direct shaft displacement flow of fluid to a reservoir of the shock assembly when a piston of the shock assembly passes by the at least one reservoir flow port during a compression stroke.

15. The shock assembly of claim 14, wherein the location of the at least one reservoir flow port marks a boundary between a primary internal bypass zone and a secondary internal bypass zone, wherein the secondary internal bypass zone is located on a side of the at least one reservoir flow port adjacent the reservoir and the primary internal bypass zone is located on an opposite side of the at least one reservoir flow port.

16. The shock assembly of claim 15, further comprising additional bypass/bleed ports located above the at least one reservoir flow port.

17. The shock assembly of claim 16, wherein the additional bypass/bleed ports are only active when the piston crossed the at least one reservoir flow port and is within the secondary internal bypass zone during the compression stroke.
